(19) United States
(12) Patent Application Publication
(10) Pub. No.: US 2007/0221557 A1
(43) Pub. Date: Sep. 27, 2007

(54) Chromatography column having flexible substrate

(75) Inventors: William E. Barber, Landenberg, PA (US); Robert D. Ricker, Middletown, MD (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: Agilent Technologies, Inc., Palo Alto, CA (US)

(21) Appl. No.: 11/387,498

(22) Filed: Mar. 23, 2006

(51) Int. Cl. B01D 15/08

(52) U.S. Cl. 210/198.2; 73/61.53; 73/61.52

(57) ABSTRACT

A device adapted to hold and compress a granular medium is disclosed. The device includes a body having an opening. A channel is positioned in fluid communication with the opening. A flexible substrate is attached to the body overlying the channel. The substrate and the channel cooperate to form a conduit in fluid communication with the opening. A compression member is mounted on the body. The compression member is engageable with the substrate. Engagement of the substrate by the compression member compresses the granular medium within the conduit. A plug blocks the opening and retains the granular medium within the conduit.

### BACKGROUND OF THE INVENTION

High performance liquid chromatography (HPLC) is a process by which one or more compounds from a chemical mixture may be separated and identified. A transport liquid, for example, a solvent, is pumped under high pressure through a column of packing medium, and a sample of the chemical mixture to be analyzed is injected into the column. As the sample passes through the column with the liquid, the different compounds, each one having a different affinity for the packing medium, move through the column at different speeds. Those compounds having greater affinity for the packing medium move more slowly through the column than those having less affinity, and this speed differential results in the compounds being separated from one another as they pass through the column.

The transport liquid with the separated compounds exits the column and passes through a detector, which identifies the molecules, for example by spectrophotometric absorbance measurements. A two dimensional plot of the detector measurements against elution time or volume, known as a chromatogram, may be made, and from the chromatogram the compounds may be identified.

For each compound, the chromatogram displays a separate curve or “peak”. Effective separation of the compounds by the column is advantageous because it provides for measurements yielding well defined peaks having sharp maxima inflection points and narrow base widths, allowing excellent resolution and reliable identification of the mixture constituents. Broad peaks, caused by poor column performance, are undesirable as they may allow minor components of the mixture to be masked by major components and go unidentified.

An HPLC column typically comprises a stainless steel tube having a bore containing a packing medium comprising, for example, silane derivatized silica spheres having a diameter between 0.5 to 50 microns, or 1-10 microns or even 1-7 microns. The medium is packed under pressure in highly uniform layers which ensure a uniform flow of the transport liquid and the sample through the column to promote effective separation of the sample constituents. The packing medium is contained within the bore by porous plugs, known as “frits”, positioned at opposite ends of the tube. The porous frits allow the transport liquid and the chemical sample to pass while retaining the packing medium within the bore.

The packing medium is slightly compressible. When the column is operated at pressures higher than about 400 bar, the packing medium experiences a volume reduction and a void forms at the high pressure end of the column. The void within the column permits mixing of the transport liquid and the chemical sample. This leads to poor column performance evidenced by broadening of the peaks. It would be advantageous to provide a column which can be operated at pressures above 400 bar without suffering a degradation of performance.

### SUMMARY OF THE INVENTION

The invention concerns a device adapted to hold and compress a granular medium. The device comprises a body having an opening therein. A channel is positioned within the body in fluid communication with the opening. The channel is adapted to hold the granular medium. A flexible substrate is attached to the body overlying the channel. The substrate cooperates with the channel to form a fluid tight conduit in fluid communication with the opening. A compression member is mounted on the body. The compression member is engageable with the substrate. Engagement of the compression member with the substrate compresses the granular medium within the conduit. A plug blocks the opening for retaining the granular medium within the conduit.

### BRIEF DESCRIPTION OF THE DRAWINGS

FIG. 1 is an exploded view of a column embodiment according to the invention;

FIG. 2 is a longitudinal sectional view of the column embodiment shown in FIG. 1;

FIG. 3 is a cross-sectional view taken at line 3-3 of FIG. 2;

FIG. 4 is a perspective view of another embodiment of a column according to the invention;

FIG. 5 is a cross-sectional view of the embodiment shown in FIG. 4;

FIG. 6 is a cross-sectional view of another embodiment of a column;

FIG. 7 is a longitudinal sectional view of the embodiment shown in FIG. 4;

FIG. 8 is a perspective view of another embodiment of a column according to the invention;

FIG. 9 is an exploded perspective view of another embodiment of a column according to the invention; and

FIG. 10 is a perspective view of a component of the column shown in FIG. 9.

### DETAILED DESCRIPTION OF THE EMBODIMENTS

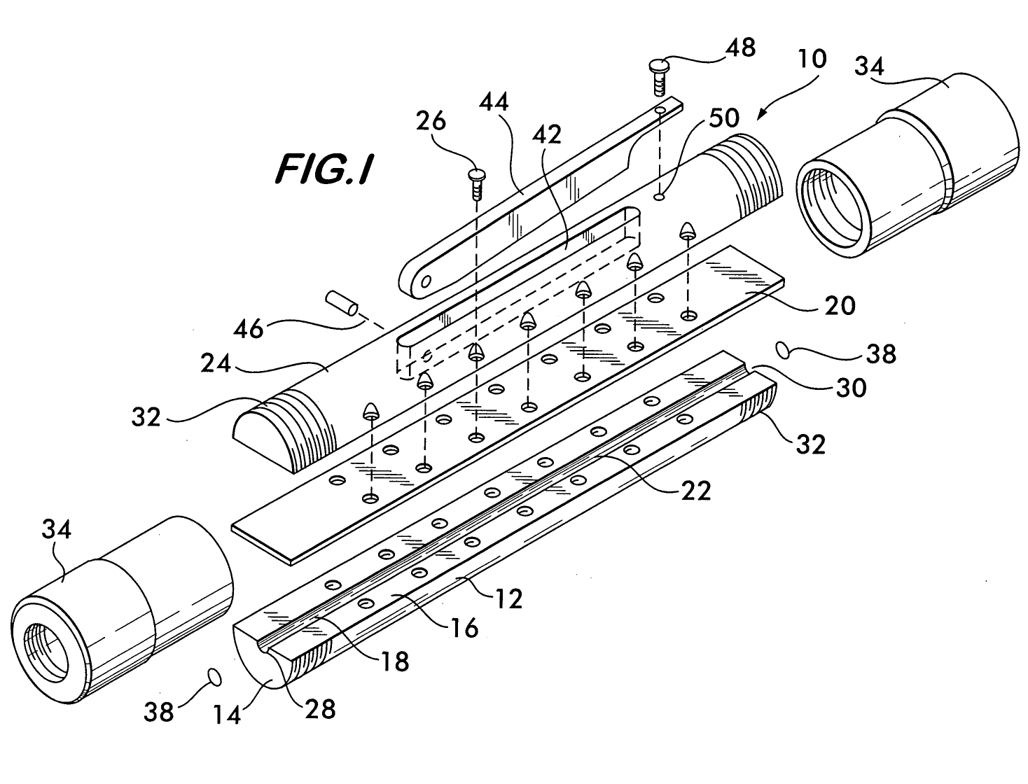

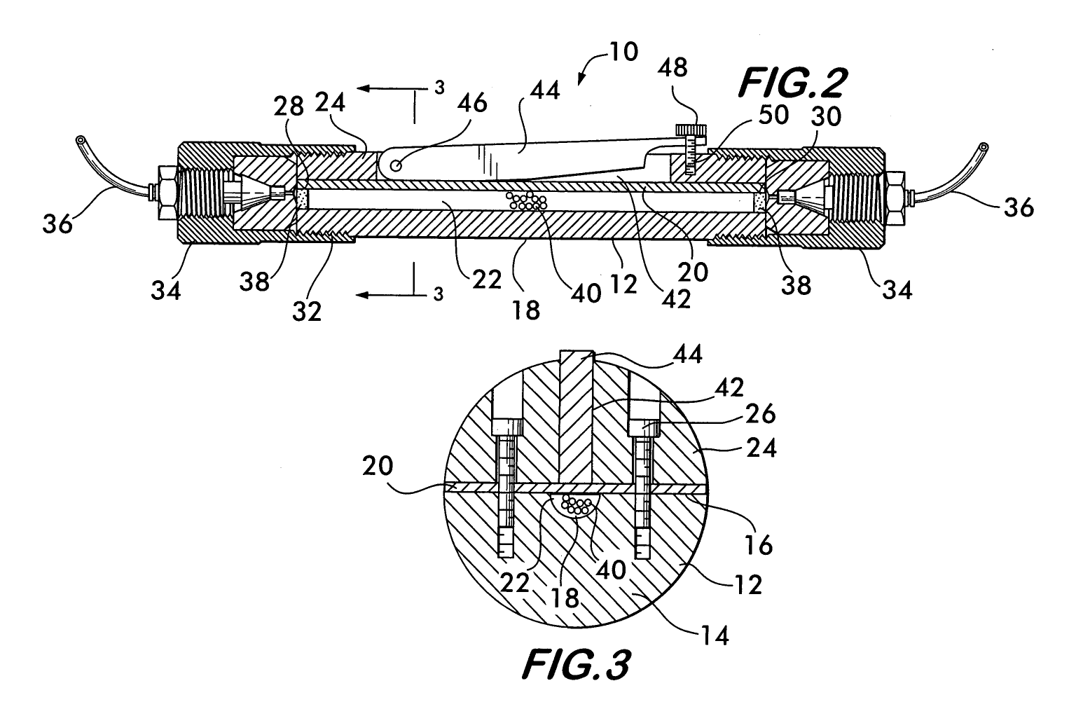

FIG. 1 shows an exploded view of a column embodiment 10 according to the invention. Column 10 includes a first body portion 12, being elongated and having a semi-circular cross section 14 with a surface 16 in which a channel 18 is positioned. A flexible substrate 20 is positioned on surface 16 overlying channel 18, the substrate and the channel cooperating to form a conduit 22 extending lengthwise along the body portion 12 as best shown in FIG. 2.

With reference again to FIG. 1, a second body portion 24 is attached to the first body portion 12 overlying the substrate 20. The first and second body portions 12 and 24 may be attached to one another using fasteners 26 which compress the substrate 20 between the body portions and form a fluid tight seal between the substrate and the first body portion 12, effectively sealing the conduit 22 along the length of the column. An inlet 28 for conduit 22 is located at one end of the column, and an outlet 30 is located at the opposite end. The ends of the column have screw threads 32 that adapt the column to receive fittings 34 which allow it to be connected to capillary tubes 36 (see FIG. 2) of a chromatograph (not shown). Porous plugs 38 are positioned at the inlet 28 and outlet 30. The plugs may be, for example, sintered metal frits or wire mesh screens that retain packing medium 40 within the conduit 22 but allow fluid, such as transport liquid for liquid chromatography, to pass through the column.

As shown in FIG. 1, the second body portion 24 has an opening, for example, in the form of a slot 42. Slot 42 extends lengthwise along column 10 and is aligned with channel 18 as shown in FIG. 3. Slot 42 extends through the second body portion 24 and provides access to the substrate 20. A compression member, for example, in the form of an elongated finger 44, is positioned within slot 42. Finger 44 is movable within the slot 42 to engage the substrate and apply lateral compression to it. The substrate is flexible and deformable, thus allowing pressure exerted by the finger to laterally compress the packing medium 40 within the conduit 22. As illustrated in FIGS. 1 and 2, finger 44 is mounted within slot 42 so as to pivot around an axis 46 oriented substantially perpendicular to the column 10. An actuator, for example, an adjustment screw 48, engages the end of finger 44 opposite its pivot axis 46. The adjustment screw 48 also engages a threaded hole 50 located in the second body portion 24. Rotation of the screw pivots the finger about axis 46 and allows for fine adjustment of the lateral compression exerted by the finger on the substrate 20 for control of the packing medium compression. Other types of actuators are also feasible including adjustable clamping bands, toggle joints and the like.

The various components of column 10 may be fabricated from stainless steel, including the substrate 20. The substrate is designed thin enough so as to be flexible and deformable and transmit the laterally applied compression to the packing medium within the conduit, yet strong enough so as to withstand the internal pressure within conduit and the compressive force exerted by the finger without failing. Steel substrate thicknesses between 0.1 mm and 5 mm are considered feasible, as well as thicknesses between 0.2 mm and 5 mm, or even between 0.2 and 1 mm.

The column 10 is assembled by positioning a porous plug at the outlet, attaching one of the fittings 34 over the outlet, and attaching another fitting 34 over the inlet without the second porous plug 38 at the inlet. The column is then connected to a device for packing the column which loads packing material into the conduit 22 under pressure. Packing pressures between 1 and 1500 bar, or 10 and 800 bar, or even 100 and 500 bar are used to load the packing medium. This operation deforms the substrate 20, which bulges outwardly in response to the pressure. Pressure on the column is relieved and the inlet fitting is then removed, the porous plug 38 is positioned overlying the inlet so as to retain the packing medium within the conduit and the fitting 34 is then reattached.

During operation within a liquid chromatograph, the column 10 may be subjected to pressures as great as 90% of the packing pressure. This may cause the packing medium to compress and form a void at the inlet 28 which will permit mixing of the sample being analyzed and lead to poor column performance. This effect may be indicated by a broadening of the chromatogram peaks. To compensate for the increased operational pressure, adjustment screw 48 may be tightened to force the finger 44 through slot 42 and into lateral engagement with substrate 20, deforming the substrate and compressing the packing medium 40 within the conduit 22. Compression of the packing medium forces it into any voids that may have formed as a result of the increased operational pressure, thus eliminating zones within the conduit where mixing may occur. This will be observed by an increase in column performance as evidenced by sharpening of peaks on the chromatogram. The packing material may also be pre-compressed as a preventive measure. This increases the life of the columns.

Columns according to the invention as described above, when used as analytical columns, may have an inner diameter between 1 mm and 25 mm, or 2 mm and 10 mm, or even 2 mm and 5 mm. The column length may be between 10 mm and 1000 mm, or 20 mm and 250 mm, or even 30 mm and 250 mm. When used as preparatory columns, the columns may have an inner diameter between 9.4 mm and 200 mm, or 9.4 mm and 100 mm, or even 20 mm and 50 mm. The column length may be between 100 mm and 2000 mm, or 150 mm and 1000 mm, or even 250 mm and 1000 mm. When used as guard columns, the columns may have an inner diameter between 1 mm and 200 mm, or 2 mm and 50 mm, or even 2 mm and 25 mm. The column length may be between 10 mm and 100 mm, or 10 mm and 50 mm, or even 10 mm and 20 mm.

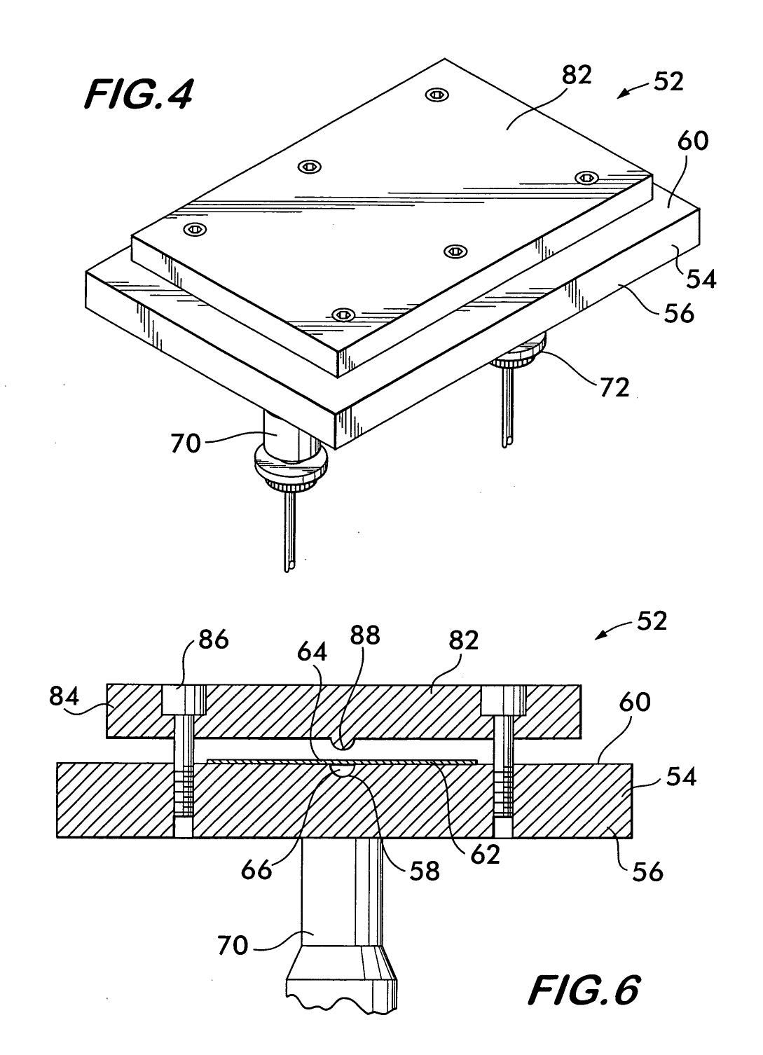

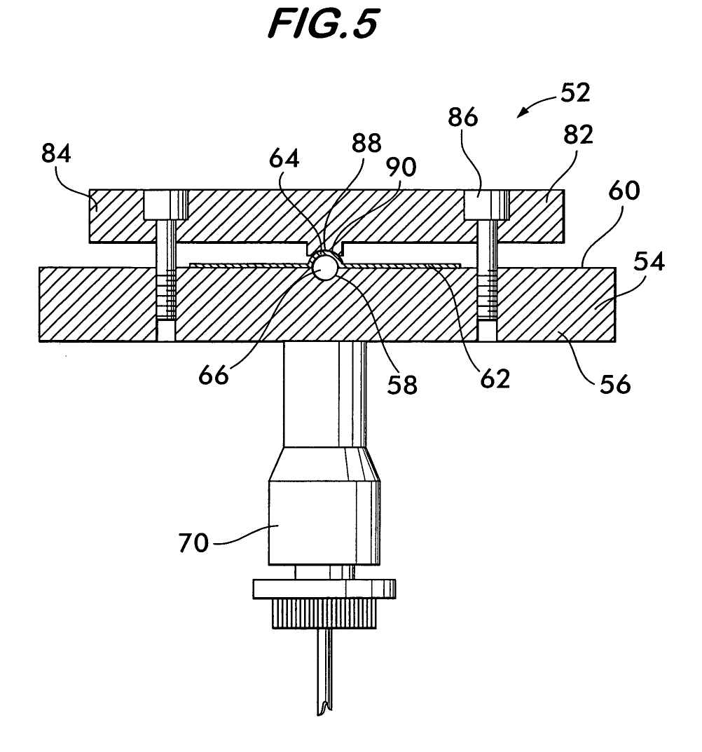

For the embodiments described above, the practical lower limit for the inner diameter is about 1 mm. Other embodiments according to the invention, described below, provide practical columns having inner diameters between about 1 mm and as small as 25 microns. One such embodiment 52 is illustrated in FIG. 4. Column 52 comprises a body 54, in this example in the form of a relatively thick plate 56. As shown in FIGS. 5 and 6, a channel 58 is positioned in a surface 60 of the body. A flexible substrate 62, generally significantly thinner than the body, is attached to the body 54. The body and substrate may be metal, such as stainless steel, and attachment of the two components may be effected by methods such as diffusion welding as described in U.S. Pat. No. 3,530,568, hereby incorporated by reference. Channel 58 may be formed by machining, laser cutting, or etching.

Flexible substrate 62 has a portion 64 overlying the channel. Together, substrate portion 64 and channel 58 cooperate to define a conduit 66 adapted to contain packing medium for chromatographic analysis. Substrate portion 64 may be curved, as shown in FIG. 5, or it may be flat as shown in FIG. 6. In the example embodiment shown in FIG. 5, the substrate portion 64 has a radius of curvature equal to that of the channel 58 so as to provide a conduit 66 having a circular cross section.

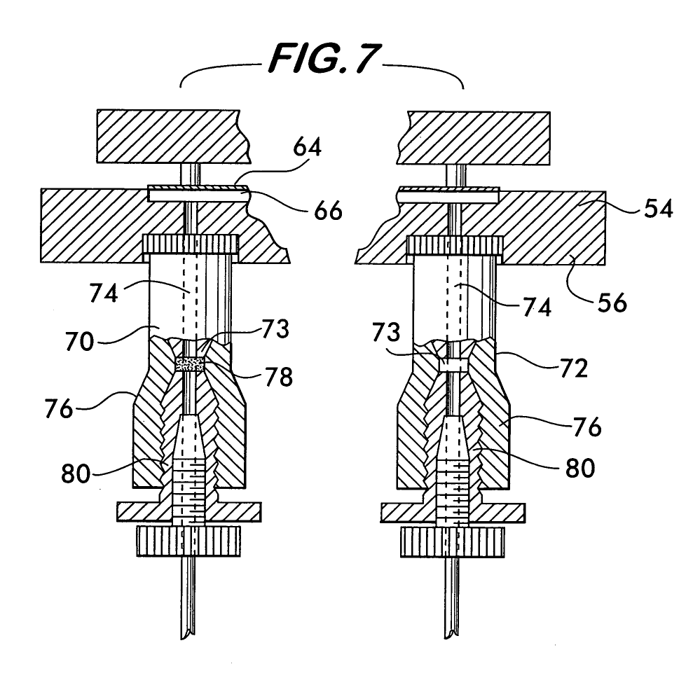

As shown in FIG. 7, two fittings 70 and 72 are in fluid communication with conduit 66 and allow the column 52 to be connected to a chromatograph (not shown). The fittings are in spaced relation at opposite ends of the conduit. Fitting 70 comprises a threaded male component 73 welded to either the body or the substrate (in this example the body 54) and having a bore 74 in fluid communication with the conduit 66. Fitting 70 is received within one end of a threaded female-female sleeve 76. A porous plug 78, for example, a frit or a screen, is positioned within the sleeve 76. The plug allows transport liquid to flow through the fitting and the column but prevents packing medium from exiting the column. The other end of the threaded female-female sleeve receives another fitting 80 for connection to an external component, for example a pump for loading the column with packing medium, or the chromatograph. Fitting 72 is substantially the same as fitting 70 and need not be described in any detail. Note that for loading a column, a female-female sleeve not having a plug 78 (see FIG. 7, fitting 72 for example) would be employed at the inlet end of the conduit 66, while the sleeve at the outlet end will have the plug to retain the packing medium. Upon completion of column packing, a female-female sleeve having a plug will replace the plugless version. Either fitting 70 or 72 may serve as the inlet or the outlet.

As shown in FIG. 5, column 52 further includes a compression member 82 overlying the substrate 62. Compression member 82 may be a plate 84 and is adjustably movable toward and away from the substrate 62 to apply compression laterally against the substrate. In this example, the movement of plate 84 is effected by threaded fasteners 86 that attach the plate to the body 54. A projection 88 extends from the compression member 82. The projection is aligned with the channel 58 and positioned so as to engage the substrate portion 64 along its length. When the compression member is moved toward the substrate 62, i.e., when fasteners 86 are tightened advancing plate 84 toward body 54, the projection 88 forcibly engages the substrate portion 64 to apply pressure laterally. The substrate portion, being relatively flexible, is deflected, causing a reduction in the volume of conduit 66 and eliminating any voids within the column caused by regions of lower packing medium density where mixing may occur. Deflections of about 0.12 mm to 0.5 mm along the length of the conduit are expected to improve column performance. For substrate portions 64 having a curvature as shown in FIG. 5, it is advantageous to provide a contact surface 90 on the end of projection 88 that has a complementary curvature adapted to receive and support the substrate portion 64.

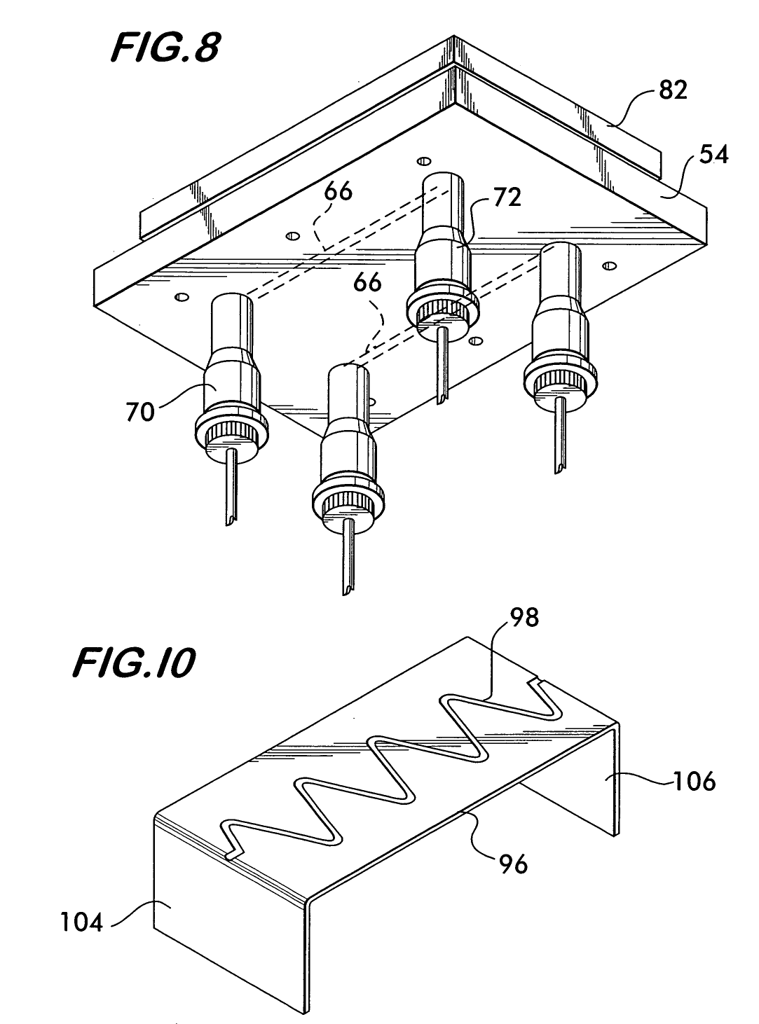

The body 54 may have a length between 5 mm and 1200 mm, or 5 mm and 300 mm, or even 5 mm and 200 mm. Widths between 5 mm and 100 mm, or 5 mm and 40 mm, or even 5 mm and 10 mm are feasible for many practical applications. The thickness of body 52 may range between 1 mm and 25 mm, or 1 mm and 10 mm, or even 1 mm and 5 mm, while the thickness of the more flexible substrate 62 may range between 0.1 mm and 5 mm, or 0.2 mm and 5 mm, or even 0.2 mm and 1 mm. Projection 88 may be, for example between 0.1 mm and 2 mm high, and the channel may have a radius of between 12 microns and 2.5 mm, or 25 microns and 1 mm, or even 25 microns and 500 microns. The effective column length, measured as the length of the conduit 66, may range between 2 mm and 1000 mm, or 2 mm and 250 mm, or even 2 mm and 150 mm. The longer lengths may be achieved despite the fact that the body and substrate are physically shorter that the effective column length because the conduit can follow a non-straight path, for example, a serpentine path, a sinusoid, a spiral or other profile. As shown in FIG. 8, a single body 54 may have more than one conduit 66 and hence provide multiple columns in a single unit.

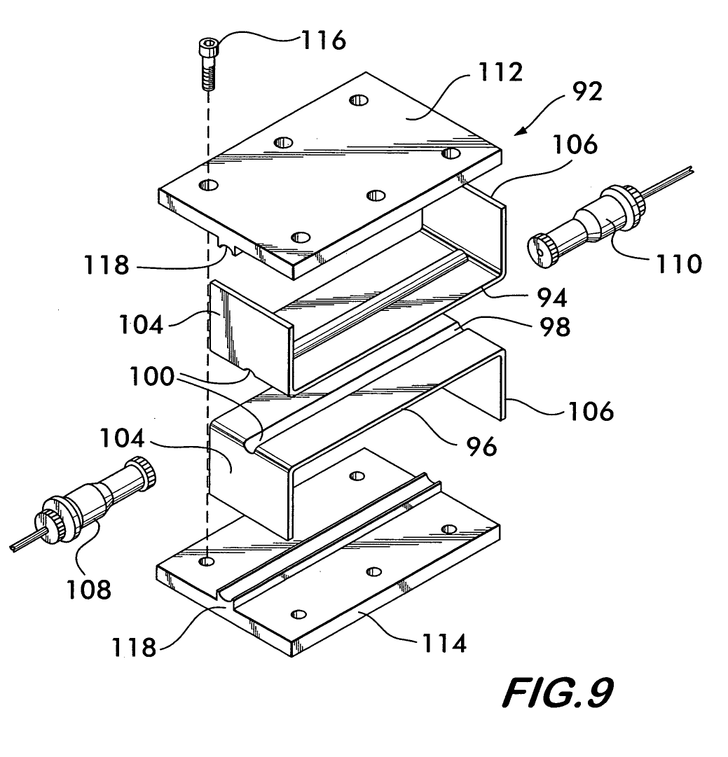

FIG. 9 shows another column embodiment 92 according to the invention. In column 92 there is no substantial difference between the body and the substrate, and the column may be thought to comprise two flexible substrates 94 and 96 attached to one another in facing relation. The substrates may be metal such as stainless steel, and are diffusion welded to one another. The thickness of the substrates may range between 0.1 mm and 5 mm, or 0.2 mm and 5 mm, or even 0.2 mm and 1 mm. The length of the substrates may range between 2 mm and 1200 mm, or 5 mm and 300 mm, or even 5 mm and 200 mm. One or both substrates have a channel 98 positioned in their facing surfaces, the channels, when two are present, being aligned and cooperating to form a conduit 100. The channels 98 may have any shape, for example, straight, as shown in FIG. 9, or non-straight, as shown in FIG. 10. The diameter of the channels may range between 25 microns and 5000 microns, or 50 microns and 2000 microns, or even 0.05 mm and 1 mm.

Conduit 100 contains the packing medium for chromatographic analysis. Support surfaces 104 and 106 are provided at each end of the substrates for the mounting of fittings 108 and 110. The support surfaces may be formed by bending the ends of each substrate 94 and 96 transversely to the substrate.

The fittings 108 and 110 are similar to those described above and provide fluid communication between the conduit 100 and external components, such as the chromatograph. The fittings may be welded to the support surfaces and are adapted to receive standard fittings as are commonly used with chromatographic equipment.

First and second compression members 112 and 114 are positioned in facing relation overlying the substrates 94 and 96. The compression members may be formed by metal plates attached to each other by threaded fasteners 116. The fasteners allow the compression members to be drawn toward each other upon tightening so as to compress the substrates laterally between them. One or both compression members may have a projection 118 aligned with the conduit 100 defined between the substrates 94 and 96 by the channels 98. Upon tightening of the fasteners 116 the projection or projections engage the substrate or substrates over the conduit and deflect the substrates to reduce the volume of the conduit and thereby eliminate any voids that could allow in transport liquid and sample mixing and result in poor column performance.

What is claimed is:

1. A device adapted to hold and compress a granular medium, said device comprising:
a body having an opening therein;
a channel positioned within said body in fluid communication with said opening;
a flexible substrate attached to said body overlying said channel, said substrate cooperating with said channel to form a fluid tight conduit in fluid communication with said opening, said conduit being adapted to hold said granular medium;
a compression member mounted on said body, said compression member being engageable with said substrate, engagement of said compression member with said substrate compressing said granular medium within said conduit; and
a plug blocking said opening for retaining said granular medium within said conduit.

2. A device according to claim 1, further comprising:
a second opening in fluid communication with said conduit; and
a second plug blocking said second opening, said plugs being porous and retaining said granular medium within said conduit while allowing fluid to pass through said body.

3. A device according to claim 2, wherein said body comprises an elongated cylinder having said openings positioned at opposite ends.

4. A device according to claim 1, further comprising first and second fittings mounted at opposite ends of said body, said fittings being adapted for connecting said column to capillary tubes of a chromatograph.

5. A device according to claim 1, wherein said compression member is pivotably movable on said body toward and away from said substrate.

6. A device according to claim 5, further comprising an actuator engaging said body and said compression member, said actuator moving said compression member into and out of engagement with said substrate.

7. A column for liquid chromatography adapted to hold a packing medium, said column comprising:
a body having an inlet and an outlet;
a channel positioned within said body and providing fluid communication between said inlet and said outlet;
a flexible substrate attached to said body overlying said channel, said substrate cooperating with said channel to form a fluid tight conduit between said inlet and said outlet, said conduit being adapted to hold said packing medium;
a compression member mounted on said body, said compression member being adjustably engageable with said substrate, engagement of said compression member with said substrate compressing said packing medium within said conduit; and
a first porous plug blocking said inlet and a second porous plug blocking said outlet for retaining said packing medium within said conduit while allowing fluid to pass therethrough.

8. A column according to claim 7, further comprising first and second fittings mounted at opposite ends of said body, said fittings being adapted for connecting said column to capillary tubes of a chromatograph.

9. A column according to claim 7, wherein said compression member is pivotably movable on said body toward and away from said substrate.

10. A column according to claim 9, further comprising an actuator engaging said body and said compression member, said actuator moving said compression member into and out of engagement with said substrate.

11. A column for liquid chromatography adapted to hold a packing medium, said column comprising:
a first body portion having a surface;
a channel positioned in said surface and extending lengthwise along said body;
a flexible substrate positioned on said surface and overlying said channel, said substrate and said channel cooperating to form a conduit through said body, said conduit being adapted to hold said packing medium;
a second body portion attached to said first body portion overlying said substrate, said second body portion effecting a fluid tight seal between said substrate and said second body portion;
an opening extending through said second body portion, said opening being aligned with said channel; and
a finger positioned within said opening and movable toward and away from said substrate, engagement of said finger with said substrate compressing said packing medium within said conduit.

12. A column according to claim 11, wherein said first and second body portions form an elongated tube.

13. A column according to claim 11, wherein said opening comprises a slot.

14. A column according to claim 13, wherein said finger is pivotably mounted within said slot.

15. A column according to claim 14, further comprising an adjustment screw engaging said finger and said second body portion, tightening of said screw pivoting said finger into engagement with said substrate and compressing said packing medium.

16. A column according to claim 11, further comprising first and second fittings mounted at opposite ends of said body, said fittings being adapted for connecting said column to capillary tubes of a chromatograph.

17. A column according to claim 16, further comprising first and second porous plugs respectively positioned at opposite ends of said conduit, said plugs retaining said packing medium within said conduit while allowing fluid to pass therethrough.

18. A column for a chromatograph, said column comprising:
a body having a channel positioned therein;
a flexible substrate attached to said body, a portion of said flexible substrate overlying said channel, said channel and said substrate portion forming a conduit;
first and second fittings mounted on one of said body and said substrate in spaced relation to each other, said fittings being in fluid communication with said conduit and adapted for connecting said conduit to said chromatograph; and
a compression member overlying said flexible substrate, said compression member having a projection aligned with said channel, said compression member being adjustably movable toward and away from said flexible substrate, said projection compressing said substrate portion lengthwise along said channel thereby deflecting said substrate portion and reducing the volume of said conduit.

19. A column according to claim 18, wherein said compression member comprises a plate attached to said body by a plurality of threaded fasteners, tightening of said fasteners moving said plate toward said flexible substrate thereby engaging said projection with said substrate portion and compressing said substrate portion lengthwise along said channel.

20. A column according to claim 18, wherein said substrate portion has a curved cross section.

21. A column according to claim 20, wherein said substrate portion and said channel are each semi-circular and have identical radii of curvature, said channel and said substrate portion being arranged to define a substantially circular cross section for said conduit.

22. A column according to claim 20, wherein said projection has a contact surface with a curvature adapted to receive and support said substrate portion.

23. A column according to claim 18, further comprising:
a second channel positioned in said body;
a second portion of said substrate overlying said second channel, said second channel and said second substrate portion forming a second conduit;
third and fourth fittings mounted on one of said body and said substrate in spaced relation to each other, said third and fourth fittings being in fluid communication with said second conduit and adapted for connecting said second conduit to said chromatograph; and
a second projection on said compression member aligned with said second channel.

24. A column according to claim 18, wherein said channel follows a non-straight path.

25. A column according to claim 18, further comprising:
a granular packing medium positioned within said conduit; and
first and second porous plugs positioned respectively within said first and second fittings, said porous plugs permitting flow of liquid through said conduit but retaining said granular packing medium within said conduit.

26. A column for a chromatograph, said column comprising:
first and second flexible substrates attached to one another in facing relation, each said substrate having a channel therein, said channels being lengthwise aligned with one another in facing relation and defining a conduit;
a pair of support surfaces positioned at opposite ends of said first and second substrates, said support surfaces being oriented transversely to said substrates;
first and second fittings mounted on said support surfaces at opposite ends of said first and second substrates, said fittings being in fluid communication with said conduit and adapted for connecting said conduit to said chromatograph; and
first and second compression members positioned overlying said first and second substrates, at least one of said compression members having a projection aligned with said conduit, said compression members being adjustably movable toward and away from one another, said projection being engageable with and compressing one of said substrates lengthwise along said conduit thereby deflecting said one substrate and reducing the volume of said conduit.

27. A column according to claim 26, wherein said compression members comprise first and second plates attached to one another in facing relation by a plurality of threaded fasteners, said first and second substrates being positioned between said first and second plates, tightening of said fasteners moving said plates toward one another thereby engaging said projection with one of said substrates and compressing said one substrate lengthwise along said conduit.

28. A column according to claim 26, wherein said conduit follows a non-straight path.

29. A column according to claim 26, wherein said channels are formed by etching said substrates.

30. A column according to claim 26, wherein said substrates are fusion welded to one another.

31. A column according to claim 26, further comprising:
a granular packing medium positioned within said conduit; and
first and second porous plugs positioned respectively within said first and second fittings, said porous plugs permitting flow of liquid through said conduit but retaining said granular packing medium within said conduit.
